(19) United States
(12) Patent Application Publication
(10) Pub. No.: US 2020/0080336 A1
(43) Pub. Date: Mar. 12, 2020

(54) PORTABLE HUNTING BLIND

(71) Applicant: PIC America, Ltd., Fuquay-Varina, NC (US)

(72) Inventor: Justin Thomas Stalek, Whitsett, NC (US)

(73) Assignee: PIC America, Ltd., Fuquay-Varina, NC (US)

(21) Appl. No.: 16/562,619

(22) Filed: Sep. 6, 2019

Related U.S. Application Data
(60) Provisional application No. 62/728,151, filed on Sep. 7, 2018.

(51) Int. Cl. E04H 15/00; E04H 15/02; E04H 15/58; A01M 31/02

(52) U.S. Cl. CPC E04H 15/001; E04H 15/02; E04H 15/50; A01M 31/025; E04H 15/58

(57) ABSTRACT

The present invention relates to a portable hunting blind that, in one configuration, is compact and easy to carry from one location to another location. In another configuration, the erect configuration, a hunting blind is formed. The portable hunting blind includes a side wall panel that extends around the hunting blind and includes a plurality of screen inserts formed in the sides of the hunting blind. Formed in a plurality of the screen inserts is a gun opening for receiving a portion of a gun.

### CROSS-REFERENCE TO RELATED APPLICATION

This application claims priority under 35 U.S.C. § 119(e) from the following U.S. provisional application: Application Ser. No. 62/728,151 filed on Sep. 7, 2018. That application is incorporated in its entirety by reference herein.

### FIELD OF THE INVENTION

The present invention relates to hunting blinds, and more particularly to a pop-up frame hunting blind.

### BACKGROUND OF THE INVENTION

A wide variety of different hunting blinds are used by hunters and nature observers to camouflage the hunters and nature observers from the wildlife being hunted or observed and to provide the hunters and nature observers protection from weather. Hunting blinds can be permanent, semi-permanent and portable structures which are placed in or near natural habitats of the wildlife being hunted. Hunting blinds that are permanent or semi-permanent are often stationery and made of wood or metal materials. The shortcomings and disadvantages of these types of hunting blinds are obvious. There are, however, portable or collapsible hunting blinds, but for the most part, these hunting blinds provide inadequate cover and do not adequately protect hunters and observers in inclement weather.

Therefore, there is a need for a portable and collapsible hunting blind that can be easily transported from location-to-location and which effectively hides the hunters or observers, and at the same time, provides substantial protection from inclement weather conditions.

### SUMMARY OF THE INVENTION

The present invention entails a portable hunting blind that includes a frame structure and a side panel wall extending around the frame and wherein the side panel wall forms a plurality of sides of the hunting blind. The side panel wall is pliable and includes two generally vertical terminal ends disposed adjacent each other and which are configured to form an entry and exit opening in the hunting blind. A roof panel is supported by the frame and extends generally downward and outwardly from an apex. The roof panel includes a lower skirt that extends downwardly over upper portions of the sides of the hunting blind. There is provided a plurality of spaced apart screen inserts in the sides of the hunting blind. A gun opening is formed in a plurality of the screen inserts and configured to receive a portion of a gun projecting from the interior of the hunting blind outwardly. The frame structure in a preferred embodiment is a collapsible pop-up frame structure that is configured to assume a collapsed configuration and an erect configuration.

### DESCRIPTION OF THE DRAWINGS AND PHOTOGRAPHS

FIG. 1 is a perspective view of the hunting blind.

FIG. 2 is a front elevational view of the hunting blind.

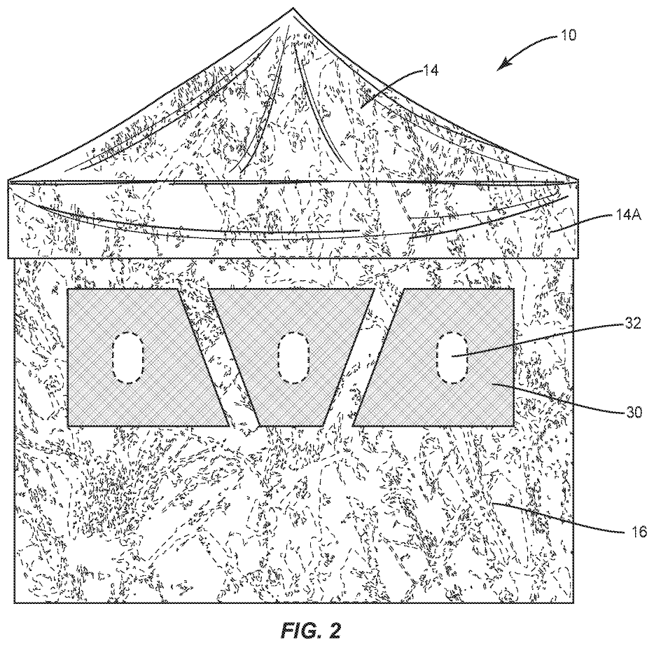

FIG. 3 is a side elevational view of the hunting blind.

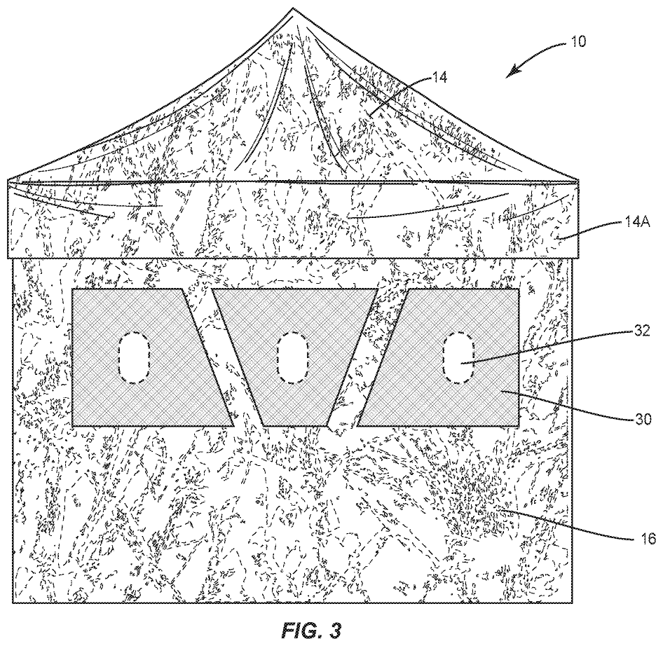

FIG. 4 is a top plan view of the hunting blind.

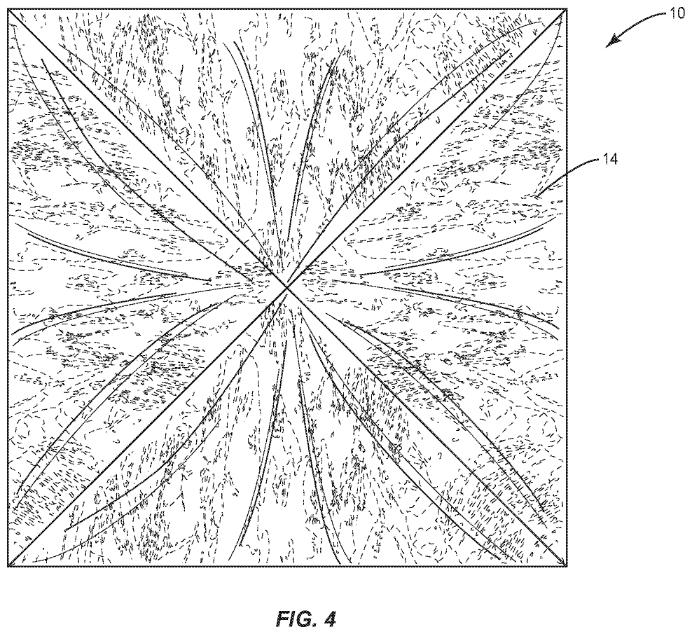

FIG. 5 is a perspective view of an alternate design for the hunting blind.

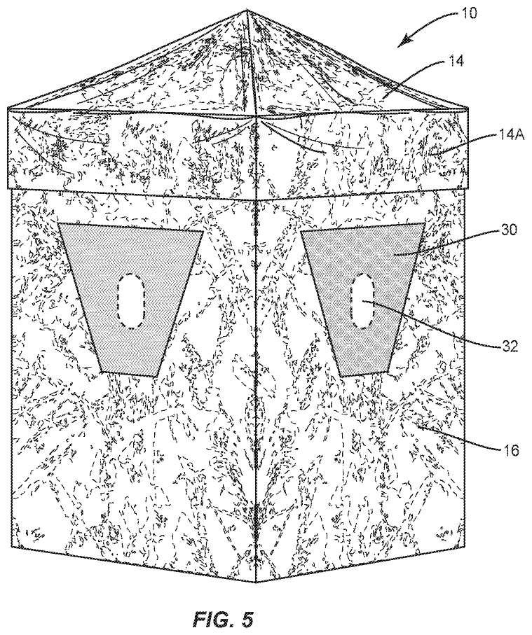

FIG. 6 is a front elevational view of the alternate design.

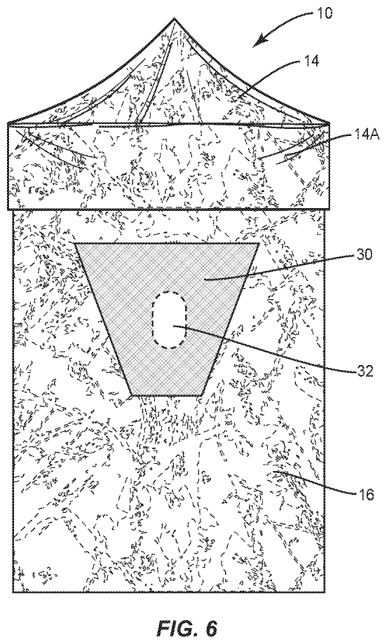

FIG. 7 is a side elevational view of the alternate design.

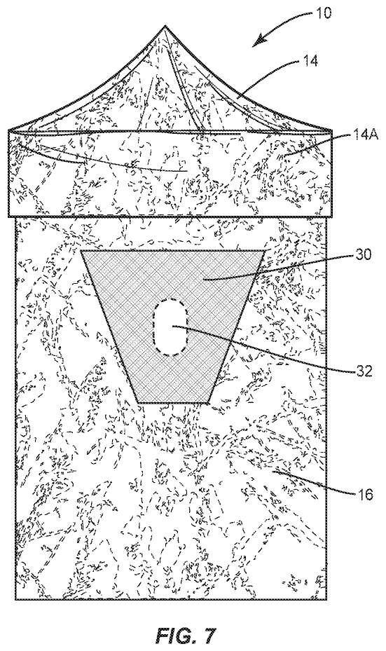

FIG. 8 is a top plan view of the alternate design for the hunting blind.

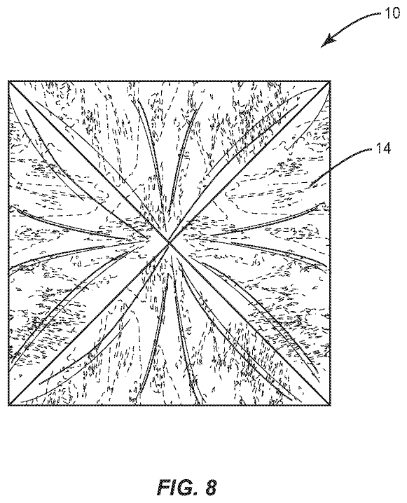

FIG. 9 is a fragmentary perspective view showing the central portion of a pop-up frame and schematically showing portions of a ceiling panel that includes a central opening through which the central portion of the pop-up frame extends.

FIG. 10 is a perspective view of the hunting blind partially assembled in the erect position and showing a truss-type network that forms a part of the pop-up frame.

FIG. 11 is a perspective view of the hunting blind partially assembled in the erect position with the side wall panel including an integrated partial ceiling shown before being secured to the frame structure.

### DESCRIPTION OF EXEMPLARY EMBODIMENT

With further reference to the drawings, the hunting blind is shown therein and indicated generally by the numeral 10. Hunting blind 10 is designed to constitute a cover for hunters or nature observers and is designed to reduce the chance that the hunters or nature observers will be detected. As discussed further herein, the hunting blind 10 is portable and can be collapsed into a relatively small compact configuration that can be easily transported and carried by the hunter.

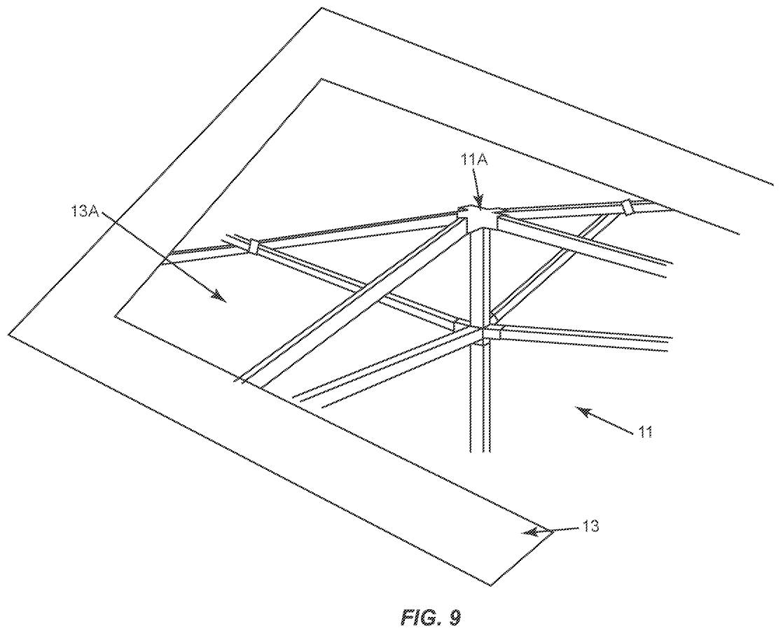

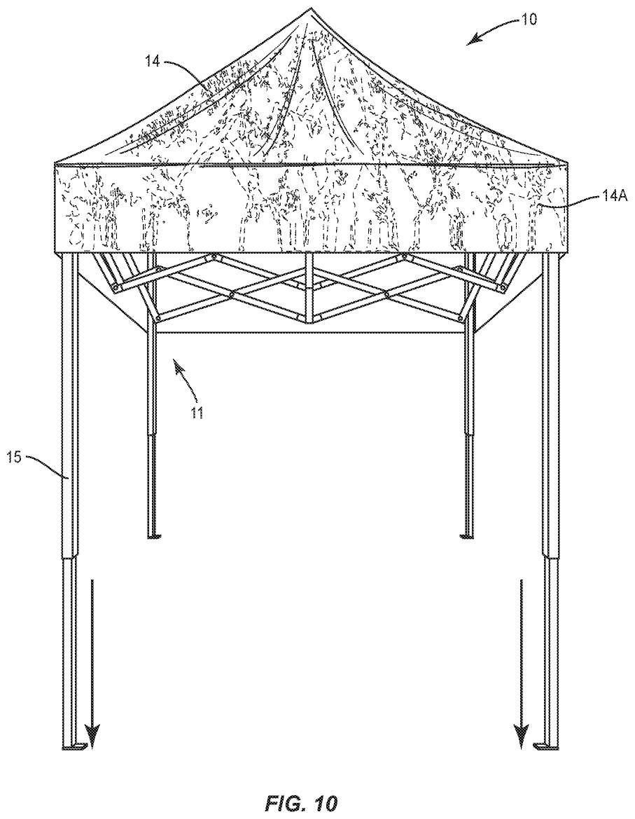

Forming a part of the hunting blind is a frame structure including a pop-up frame 11. Details of the pop-up frame 11 are not dealt with herein. However, the pop-up frame 11 is collapsible and expandable. When collapsed, the pop-up frame, along with the roof and side panels of the hunting blind, can be easily carried from one location to another. When expanded outwardly and extended vertically, the pop-up frame forms an interior support structure for the hunting blind. See FIG. 10. Note that when erected, the pop-up frame 11 includes corner posts 15 and a generally horizontal perimeter frame 17 that extends between upper portions of the corner post. Also, the pop-up frame includes a series of collapsible and expandable trusses that extend from a central point of the pop-up frame to the outer structure including the perimeter frame 17. Note that the truss network is shown in FIG. 10. In FIG. 9, the central portion of the pop-up frame 11 is shown. Note that it includes an apex 11A which extends upwardly and engages the top panel at the apex of the roof. The pop-up frame can vary in design, construction and materials. In one embodiment, it is preferred that the pop-up frame be constructed of a relatively lightweight material, such as plastic, aluminum or other suitable materials.

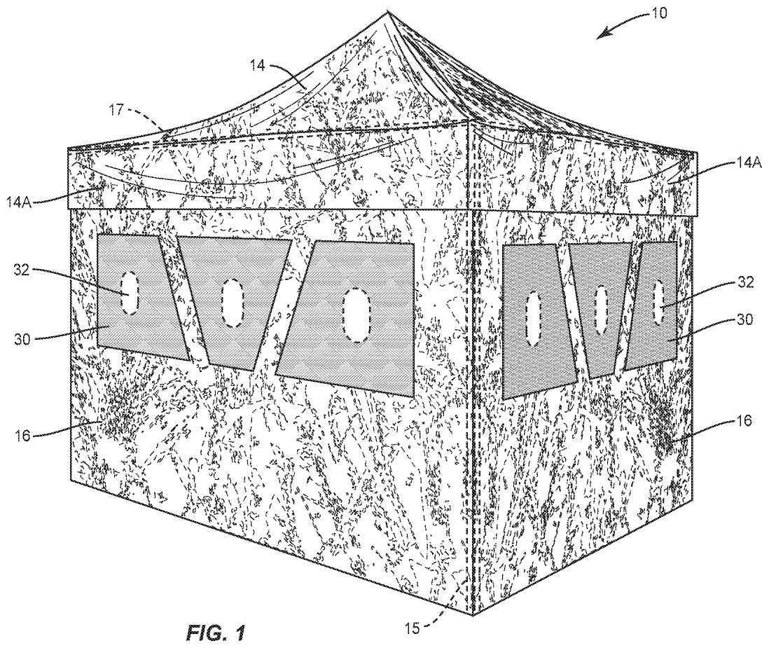

Forming a part of the portable hunting blind 10 is the roof panel 14. As discussed above, the roof panel is supported by the pop-up frame 11 and is effectively divided into four roof sections that extend outwardly and downwardly from the apex or central point of the roof. See FIG. 1. Note that each roof section extends downwardly from the apex of the roof and becomes progressively wider towards the outside boundaries of the hunting blind. In addition, the roof panel 14 includes a skirt 14A that extends from the lower portion of the roof panel and slightly drapes over the sides of the hunting blind 10. The roof panel can be constructed of various materials, but in one embodiment the materials of the roof panel include a pliable waterproof fabric.

Sides of the portable hunting blind 10 are formed by a wraparound pliable side wall 16. This also, in a preferred embodiment, is constructed of a waterproof fabric. The side wall 16 extends completely around the sides of the hunting blind and is disposed exteriorly of the vertical posts 15 of the pop-up frame structure. Roof panel 14 and the surrounding side wall 16 are designed so as to completely hide the frame structure so that outside exposure only includes the roof panel 14 and the side walls 16. In one exemplary embodiment, the roof panel 14 and wraparound sides 16 include a camouflaged design. In addition to a camouflage design, the roof panel 14 and the wraparound side wall 16 can include other designs that tend to obscure the presence of the hunting blind.

Roof panel 14 and the side wall 16 are secured together and suspended by employing ties or other suitable means to connect the roof panel and the side wall to the frame structure. In particular, the roof panel 14 and side wall 16 can be secured by ties, hook and loop fasteners, or other suitable means to the pop-up frame 11. In the case of the side wall 16, in a preferred embodiment, such includes a single panel that effectively wraps around all four sides of the hunting blind 10 and includes terminal ends that can be connected together by a zipper or various means. In the erect configuration, the terminal ends of the side walls 16 are disposed vertically and terminate closely adjacent each other so as to form an entry opening or exit opening for the hunting blind 10. In one embodiment, the terminal ends of the side wall 16 is provided with a zipper that enables the side wall to be securely wrapped around the sides of the hunting blind 10 and suspended from the pop-up frame to effectively close the hunting blind from all sides.

In addition, the roof panels 14 and the side walls can be constructed of materials that include scent suppressing material that tends to suppress the scents given off by hunters or nature observers housed within the hunting blind 10.

Formed in the side wall 16 is a series of screen inserts 30. Screen insert 30 provides for ventilation through the hunting blind 10, but is designed such that hunters within the hunting blind are not easily detected through the screen inserts. In one or more screen inserts 30, there is provided a gun opening 32. The gun opening 32 is configured to receive a portion of a gun. The term “configured to” as used herein means designed to. Gun opening 32 enables hunters within the hunting blind 10 to project a gun through the gun opening towards a target that lies outside of the hunting blind. Also, the surrounding side wall 16 includes interior closure flaps that can be extended over the screen inserts 30 to effectively close that area of the hunting blind. The closure flaps are configured to assume a position over the screen inserts 30 or a position adjacent the screen inserts. In one exemplary embodiment, when the closure flaps are not employed to cover the screen inserts, the closure flaps can be rolled up and tied or otherwise secured to the interior side of the side wall of the hunting blind. Thus, in this example, by simply untying or unsecuring the closure flaps enables the closure flaps to fall down and effectively cover the screen inserts.

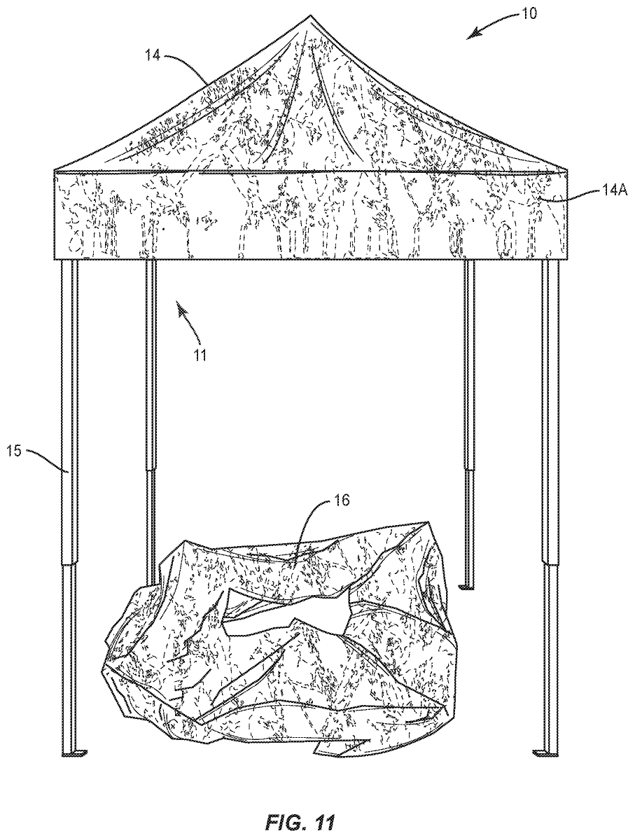

Further, the hunting blind 10 includes a pliable ceiling panel 13 that stretches across a top portion of the hunting blind. The ceiling panel, shown schematically and referred to by the numeral 13 (see FIG. 9) is suspended in the hunting blind. Note that the ceiling panel 13 includes a central opening 13A. As illustrated in FIG. 9, this enables the central portion of the pop-up frame 11 to project upwardly through the opening 13A in the ceiling panel 13. The ceiling panel 13 can be incorporated in various ways. In a preferred embodiment, the ceiling panel 13 forms a part of the side wall panel 16. See FIG. 11. Note the central opening 13A formed in a portion of the panel shown therein. The ceiling panel is suspended by clips that connect the ceiling panel to various portions of the pop-up frame 11 that extends underneath the ceiling panel. In other embodiments, the ceiling panel 13 can be independent of the side wall panels 16. In this case, the ceiling panel 13 is secured to the side wall panel 16 or the roof panel 14 by a zipper or other suitable means.

Finally, the hunting blind 10 includes a bottom. The bottom is a pliable fabric or other material that forms the bottom of the hunting blind. It is attached by a zipper or other suitable means to a lower terminal edge of the surrounding side wall 16.

There are many advantages to the portable hunting blind of the present invention. Its portability is a significant advantage. The entire hunting blind can be collapsed and placed in a carrying bag or case which makes it easier for hunters to transport and deploy. Further, the hunting blind 10 is roomy and provides a comfortable setting for hunters and nature observers. Furthermore, the portable hunting blind can be erected and taken down quickly and easily.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A portable hunting blind, comprising:
a collapsible frame;
a single side panel wall extending around the frame and wherein the single side panel forms a plurality of sides of the hunting blind;
the side panel wall being pliable and including two generally vertical terminal ends disposed adjacent each other and which are configured to form an entry and exit opening in the hunting blind;
a pliable roof panel supported on the frame and extending generally downwardly and outwardly from a generally central apex;
the roof panel including a lower skirt that extends downwardly over upper portions of the sides of the hunting blind;
a plurality of spaced apart screen inserts formed in the sides of the hunting blind;
a gun opening formed in a plurality of the screen inserts and configured to receive a portion of a gun projecting from the interior of the hunting blind outwardly; and
wherein the frame is configured to assume a collapsed configuration and an erect configuration.

2. The portable hunting blind of claim 1 further including a pliable ceiling panel that extends inwardly from the sides of the hunting blind and includes a generally central opening in the hunting blind through which a portion of the frame projects, the frame projecting through the central opening of the ceiling panel and engaging the roof panel and at least partially supporting the roof panel.

3. The portable hunting blind of claim 2 wherein the roof panel and the side wall panel includes scent suppressing material that suppresses the scents given off by hunters housed in the hunting blind.
